(19) United States
(12) Patent Application Publication
(10) Pub. No.: US 2014/0102381 A1
(43) Pub. Date: Apr. 17, 2014

(54) PET DIAPER HOLDER

(71) Applicant: Janet Marie Siano, Colonia, NJ (US)

(72) Inventor: Janet Marie Siano, Colonia, NJ (US)

(21) Appl. No.: 14/052,736

(22) Filed: Oct. 12, 2013

Related U.S. Application Data
(60) Provisional application No. 61/714,060, filed on Oct. 15, 2012.

(51) Int. Cl. A01K 29/00

(52) U.S. Cl. CPC A01K 29/00
USPC 119/863

(57) ABSTRACT

The present invention relates to a pet care apparatus. Specifically, the invention relates to a suspender-like apparatus that is used securely hold a pet diaper on a pet.

### CROSS REFERENCE TO RELATED APPLICATIONS

This application claims the benefit of U.S. Provisional Patent Application No. 61/714,060, filed Oct. 15, 2012, the entire disclosure of which is incorporated herein by reference.

### FIELD OF THE INVENTION

The present invention relates to a pet care apparatus. Specifically, the invention relates to a suspender-like apparatus that is used securely hold a pet diaper on a pet.

### BACKGROUND OF THE INVENTION

One of the most common problems that pet owners face is a pet, such as a dog or a cat, that is either incontinent or unable to eliminate its waste in an appropriate manner, whether that be outside in the case of a dog or in a litter box in the case of cat. In such cases, pet owners are often forced to place a diaper on their pet to prevent the pet from eliminating in inappropriate places. These pet diapers, however, can often be unreliable by being either poor fitting or easily removed by the pet.

Therefore, there is a need in the art for a pet care apparatus that cures the defects of current pet diapers by making those pet diapers better fitting and more resistant to the pet's attempts to remove the pet diaper. These and other features and advantages of the present invention will be explained and will become obvious to one skilled in the art through the summary of the invention that follows.

### SUMMARY OF THE INVENTION

The present invention provides a pet diaper holder that is used to more securely fit a pet diaper to the body of a pet. In a preferred embodiment, the pet diaper holder is comprised of a series straps, clips, and adjustment means that are configured to provide an adjustable suspender-like apparatus that allows a pet diaper to be fitted to a pet in a more tailored fashion.

According to an embodiment of the present invention, a pet diaper holder apparatus includes: a suspender apparatus, comprising a collar component, one or more top straps, one or more bottom straps and a plurality of fastener means, wherein each of said one or more top straps and each of said one or more bottom straps are at one end connected to said collar component and at the other end connected to one of said plurality of said fastener means.

According to an embodiment of the present invention, the pet diaper holder apparatus further includes a plurality of adjustment means wherein each of said one or more top straps and each of said one or more bottom straps are configured with one of said plurality of adjustment means.

According to an embodiment of the present invention, the collar component is further comprised of a fabric cover.

According to an embodiment of the present invention, the collar component is an elastic collar.

According to an embodiment of the present invention, the collar component is an adjustable collar.

According to an embodiment of the present invention, the plurality of adjustment means are ratchet adjusters.

According to an embodiment of the present invention, the plurality of fastener means are suspender clips.

According to an embodiment of the present invention, a method for removably securing a diaper on a pet includes the steps of: securing a pet diaper holder apparatus to the neck of a pet via a collar component; securing one or more top straps of said pet diaper holder apparatus via one or more fastener means to said diaper, wherein said diaper has been placed on said pet; and securing one or more bottom straps of said pet diaper holder apparatus via one or more fastener means to said diaper, wherein said diaper has been placed on said pet.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is an illustrative example of a pet diaper holder in accordance with an embodiment of the present invention;

FIG. 2 is an illustrative example of a pet wearing a pet diaper holder in accordance with an embodiment of the present invention;

FIG. 3 is an alternate illustrative example of a pet wearing a pet diaper holder in accordance with an embodiment of the present invention; and

FIG. 4 is an alternate illustrative example of a pet diaper holder in accordance with an embodiment of the present invention.

### DETAILED DESCRIPTION OF THE INVENTION

The present invention relates to a pet care apparatus. Specifically, the invention relates to a suspender-like apparatus that is used securely hold a pet diaper on a pet.

According to a preferred embodiment of the present invention, a pet diaper holder may be a suspender apparatus. In the preferred embodiment, the suspender apparatus will be sufficiently adjustable so as to allow a pet diaper to be properly fitted and secured to the body of a pet. One of ordinary skill in the art would appreciate that a pet diaper holder may be embody a number of different designs, and embodiments of present invention are contemplated for use with any such design.

According to a preferred embodiment of the present invention, a suspender apparatus may be comprised of a collar component, one or more top straps, one or more bottom straps, a plurality of adjustment means, and a plurality of fastener means. In alternate embodiments, the suspender apparatus may comprise fewer or additional components. One of ordinary skill in the art would appreciate that a suspender apparatus could be configured with a variety of components, and embodiments of the present invention are contemplated for use with and such component.

According to an embodiment of the present invention, the suspender apparatus of a pet diaper holder may be comprised of a collar component. In a preferred embodiment, the collar component may be an elastic collar comprising a single, continuous loop of stretchable material that can be stretched to fit over a pet's head. In the preferred embodiment, the elastic collar may further include a fabric cover. In alternate embodiments, the collar component may be an adjustable collar comprising a single piece of inelastic material and a sizing means. One of ordinary skill in the art would appreciate that the collar component could be designed in a number of configurations, and embodiments of the present invention are contemplated with any such configuration.

According to an embodiment of the present invention, the elastic collar may further include a fabric cover. In a preferred embodiment, the fabric cover is a piece of fabric that encompasses that the loop of elastic that comprises the elastic collar. In the preferred embodiment, the fabric cover is intended to increase the comfort of the collar component. The fabric cover may further serve to enhance the visual appeal of the collar component. One of ordinary skill in the art would appreciate there are many suitable designs and uses for a fabric cover, and embodiments of the present invention are contemplated for use with and such designs or uses.

According to an embodiment of the present invention, the adjustable collar may include a sizing means. In a preferred embodiment, the sizing means is any suitable method that allows the adjustable collar to be adapted to different sizes as the adjustable collar is not a continuous loop, but rather a strap of material that has corresponding connectors at each end. Examples of sizing means include, but are not limited to i) a buckle and sizing holes spaced along the collar strap or ii) a connector mechanism with a means to adjust the length of the collar strap. One of ordinary skill in the art would appreciate that there are numerous mechanisms that would be suitable to use as a sizing means, and embodiment of the present invention are contemplated for use with any such mechanism.

According to an embodiment of the present invention, the suspender apparatus of a pet diaper holder may be comprised of one or more top straps. In a preferred embodiment, the one or more top straps are at one end connected to the collar component and at the other end connected to an fastener means. In the preferred embodiment, the top strap may be further comprised of an adjustment means. One of ordinary skill in the art would appreciate there are numerous useful configurations for the one or more tops straps of a pet diaper holder, and embodiments of the present invention are contemplated for use with any such configuration.

According to an embodiment of the present invention, the suspender apparatus of a pet diaper holder may be comprised of one or more bottom straps. In a preferred embodiment, the one or more bottom straps are at one end connected to the collar component and at the other end connected to an fastener means. In the preferred embodiment, the bottom strap will connect to the collar component at the opposite side of the loop that comprises the collar component. The preferred embodiment of the bottom strap may be further comprised of an adjustment means. One of ordinary skill in the art would appreciate there are numerous useful configurations for the one or more bottom straps of a pet diaper holder, and embodiments of the present invention are contemplated for use with any such configuration.

According to an embodiment of the present invention, the suspender apparatus of a pet diaper holder may be comprised of a plurality of adjustment means. In a preferred embodiment, the adjustment means is a ratchet adjuster. In the preferred embodiment, the ratchet adjuster is connected to a top or bottom strap. With the ratchet adjuster is place, a user can adjust the length of that strap to ensure that the pet diaper holder provides a secure fit that is tailored to body of the user's pet. One of ordinary skill in the art would appreciate that there are numerous suitable adjustment means that would be functional with the pet diaper holder, and embodiments of the present invention are contemplated for use with any such adjustment means.

According to an embodiment of the present invention, the suspender apparatus of a pet diaper holder may be comprised of a plurality of fastener means. In a preferred embodiment, the fastener means is attached to a top or bottom strap at the end of the strap that is opposite from where the strap attaches to the collar component. In the preferred embodiment, the fastener means is a clip. In alternate embodiments, the fastener means may include, but are not limited to a button, a snap, clasp, hook-an-loop fastener, or other suitable fastener. One of ordinary skill in the art would appreciate that there are numerous suitable fastener means that would be functional with the pet diaper holder, and embodiments of the present invention are contemplated for use with any such fastener means.

### Exemplary Embodiments

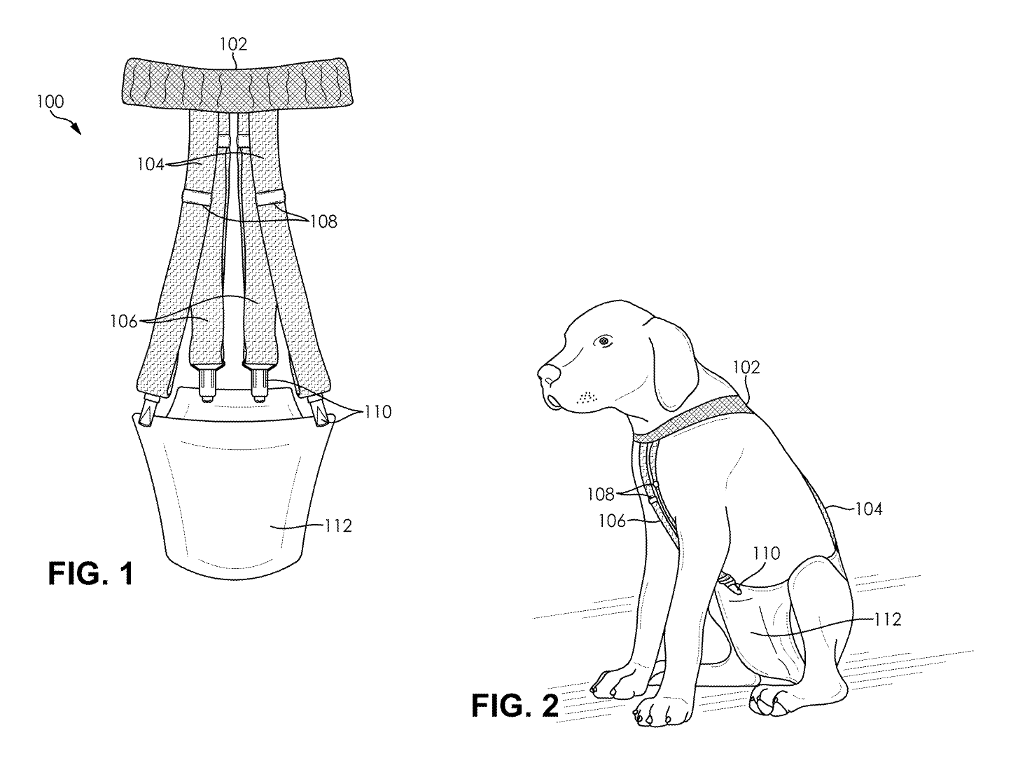

Turning now to FIG. 1, an illustrative example of a pet diaper holder in accordance with an embodiment of the present invention. In this illustration, a pet diaper holder 100 comprising of a suspender apparatus is shown. In a preferred embodiment there are two top straps 104 and two bottom straps 106 that connect to opposite sides of the collar component 102. Each top strap 104 and bottom strap 106 is at one end connected to the collar component and at the other end to a fastener means 110. Furthermore, each top strap 104 and each bottom strap 106 may also be configured with an adjustment means 108. Collectively, the components of the pet diaper holder 100 function to securely hold a diaper 112 on a pet's body.

Turning now to FIG. 2, an illustrative example of a pet wearing a diaper and a pet diaper holder. In this illustration, a pet diaper holder is used to securely hold a diaper onto the pet's body. In a preferred embodiment, the collar component 102 goes over or around the pet's and rests around the pet's neck area. Next the top straps 104 and the bottom straps 106 are connected to the diaper 112 using the fastener means 110. Then adjustments are made to the top straps 104 and the bottom straps 106 using the adjustment means 108 to ensure the straps are tailored to the pet's body. Once all of the connections and adjustments are made, the diaper 112 will be held firmly in place on the pet's body.

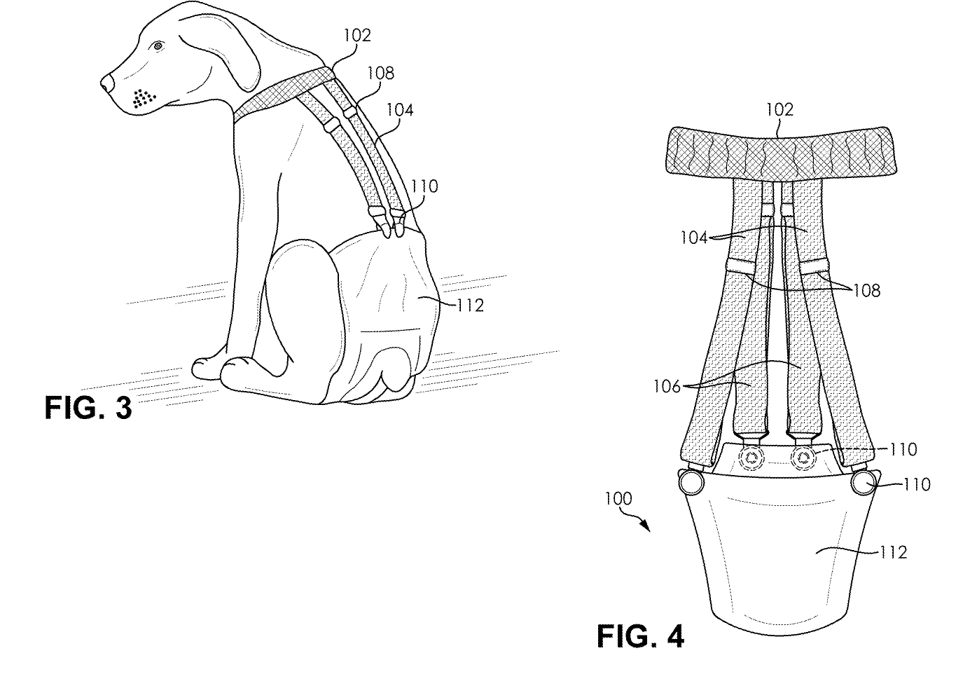

Turning now to FIG. 3, an illustrative example of a pet wearing a diaper and a pet diaper holder. In this illustration, a pet diaper holder is used to securely hold a diaper onto the pet's body. In a preferred embodiment, the collar component 102 goes over or around the pet's and rests around the pet's neck area. Next the top straps 104 and the bottom straps (not shown) are connected to the diaper 112 using the fastener means 110. Then adjustments are made to the top straps 104 and the bottom straps (not shown) using the adjustment means 108 to ensure the straps are tailored to the pet's body. Once all of the connections and adjustments are made, the diaper 112 will be held firmly in place on the pet's body.

Turning now to FIG. 4, an illustrative example of a pet diaper holder in accordance with an embodiment of the present invention. In this illustration, a pet diaper holder 100 comprising of a suspender apparatus is shown. In a preferred embodiment there are two top straps 104 and two bottom straps 106 that connect to opposite sides of the collar component 102. Each top strap 104 and bottom strap 106 is at one end connected to the collar component and at the other end to a fastener means 110. Furthermore, each top strap 104 and each bottom strap 106 may also be configured with an adjustment means 108. Collectively, the components of the pet diaper holder 100 function to securely hold a diaper 112 on a pet's body.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A pet diaper holder apparatus, said apparatus comprising:
a suspender apparatus, comprising a collar component, one or more top straps, one or more bottom straps and a plurality of fastener means,
wherein each of said one or more top straps and each of said one or more bottom straps are at one end connected to said collar component and at the other end connected to one of said plurality of said fastener means.

2. The apparatus of claim 1, further comprising a plurality of adjustment means wherein each of said one or more top straps and each of said one or more bottom straps are configured with one of said plurality of adjustment means.

3. The apparatus of claim 1, wherein said collar component is further comprised of a fabric cover.

4. The apparatus of claim 1, wherein said collar component is an elastic collar.

5. The apparatus of claim 1, wherein said collar component is an adjustable collar.

6. The apparatus of claim 2, wherein said plurality of adjustment means are ratchet adjusters.

7. The apparatus of claim 2, wherein said plurality of fastener means are suspender clips.

8. A method for removably securing a diaper on a pet, said method comprising:
securing a pet diaper holder apparatus to the neck of a pet via a collar component;
securing one or more top straps of said pet diaper holder apparatus via one or more fastener means to said diaper, wherein said diaper has been placed on said pet; and
securing one or more bottom straps of said pet diaper holder apparatus via one or more fastener means to said diaper, wherein said diaper has been placed on said pet.
